(19) United States
(12) Patent Application Publication
(10) Pub. No.: US 2017/0203280 A1
(43) Pub. Date: Jul. 20, 2017

(54) ADSORBENT PARTICLE PROCESS MANAGEMENT

(71) Applicant: WILTON TRUSTEES (IOM) LIMITED, Isle of Man (GB)

(72) Inventor: Kim Patchett, Essex (GB)

(21) Appl. No.: 15/328,183

(22) PCT Filed: Aug. 4, 2015
(86) PCT No.: PCT/GB2015/052252

§ 371 Date: Jan. 23, 2017

(30) Foreign Application Priority Data
Aug. 6, 2014 (GB) 1413962.0

(51) Int. Cl. B01J 20/32; B01J 20/28; B01J 20/18; B01J 20/30; B01J 20/22

(52) U.S. Cl. CPC B01J 20/3225; B01J 20/3042; B01J 20/3028; B01J 20/226; B01J 20/18; B01J 20/28004; B01J 20/28028; B01J 20/28038

(57) ABSTRACT

A method is provided for managing microporous and/or mesoporous and/or macroporous small particle adsorbent powders within a manufacturing process to minimize atmospheric dust. The adsorbent powder is processed by spray-drying to form larger diameter spherical particles. The larger diameter spherical particles are then dispersed in a controlled manner so as to be brought into intimate contact with a substrate. The resultant powder-and-substrate matrix is then subjected to an alternating electrical field (AEF) via an alternating power supply, thereby to reduce the spray-dried powder back to its original small particle state, whilst remaining in intimate contact with the substrate.

The present invention relates to the process management of adsorbent particles that in their natural or synthesized state have a mean particle diameter of between about 0.1 μm and 40 μm.

Adsorbent particles within the present invention may include but are not limited to microporous, mesoporous or macroporous materials comprising Zeolites, Porous Glass, Activated Carbon, Clays, Silicon Dioxide or Metal Organic Frameworks. Such adsorbent particles may be either hydrophilic of hydrophobic. Microporous materials are those having pore diameters of less than 2 nm; mesoporous materials have pore diameters of between 2 nm and 50 nm; and macroporous materials have pore diameters of greater than 50 nm.

Although the physics is not yet fully understood, some of the factors affecting the ability of powder to flow include particle size, moisture content on the surface of or within the particles, the air volume between the particles, consolidation of the particles, inter-particle electrostatic charge, the shear rate of the particles, the surface texture of the particles and the surface area of the particles.

Generally, microporous, mesoporous and macroporous particles of adsorbent materials have particle sizes in the range of between 0.1 μm and 40 μm and at ambient temperature, pressure and humidity do not flow well, with individual particles tending to duster together to form random sized clumps of powder. A similar clustering or clumping effect is often seen in the domestic kitchen with corn flour.

This random clustering effect can inhibit the flow control required in distributing or dispersing the powders within certain industrial processes where precisely metered volumes of distribution or dispersion are required.

Further, it is well understood that particles with an aerodynamic diameter of between 0.5 μm and 10 μm may easily settle within the transfer region of the human lungs (the Alveoli) and may lead to acute or chronic ill health effects depending upon the type of powder and its specific chemical and physical composition.

Particles of aerodynamic diameter in the range of 0.5 μm and 10 μm are defined as being within the respirable range. Particles of a size below the respirable range may be exhaled naturally after entering the lungs. Particles of a size above the respirable range are removed by the impingement of nasal hairs and very fine hairs (Cilia) that line the bronchi and trachea and trap foreign bodies within the respiratory system. Trapped foreign bodies are covered in mucus and passed out up into the throat where they are swallowed, sneezed or spat out. Mucus is used to ensure that particles do not become re-entrained in the inhalation flow and ultimately particles are discharged from the body thereby protecting the lungs from particle ingress.

Airborne particles have irregular shapes, and their aerodynamic behaviour is expressed in terms of the diameter of an idealised spherical particle known as the aerodynamic diameter. Particles are sampled and described on the basis of their aerodynamic diameter, which is usually simply referred to as particle size. Particles having the same aerodynamic diameter may have different dimensions and shapes. The aerodynamic diameter of an irregular particle is defined as the diameter of the spherical particle with a density of 1000 kg m⁻³ and the same settling velocity as the irregular particle.

In the United Kingdom, the threshold limit value (TLV) applied to particles within the respirable range have been published by the Health and Safety Executive (HSE), but the Control of Substances Hazardous to Health, COSHH, act 1988, introduced the Maximum Exposure Limit (MEL) and the Occupational Exposure Standard (OES).

Historic TLV values and the level of hazard that they pose are:
Group 1—very dangerous, 0 μg m⁻³ to 50 μg m⁻³, as they readily give rise to fibrosis and include: beryllium, silica in the cristobalite form and blue asbestos (5 fibres/cc and less than 5 μm in length), it being noted that asbestos is not classified using aerodynamic diameter due to its unusual fibre like shape;
Group 2—dangerous, 50 μg m⁻³ to 250 μg m⁻³, including: asbestos (other forms of and with 5 fibres/cc>5 μm in length), silica such as quartz and mixed powders containing 20% or more of silica;
Group 3—moderate risk, 250 μg m⁻³ to 1000 μg m⁻³, including mixed powders of <20% silica, talc, mica, kaolin, cotton, organic dust, graphite and coal; and
Group 4—low risk, >1 mg m⁻³, including cement powder, limestone, glass, barites, perlite, iron oxide, magnesia and zinc oxide.

Of course, sensible precautions such as the wearing of suitable dust masks within the working environment may protect against the ingress of particles within the respirable range into the lungs but in addition to the human health hazards associated with processing small particles, it may also be the case that contamination of the end product in manufacture or the production machinery itself may be problematic.

Consequently, it is desirable to provide a process for managing adsorbent particles whereby adsorbent particles are made to flow easily for precise control in distributing or dispersing said adsorbent particles within industrial manufacturing processes without creating substantial atmospheric dust in the respirable range of between 0.5 μm and 10 μm, whilst at the same time maintaining the full functionality and efficacy of the properties of the powder in its natural or synthesised small particle state.

The present invention thus seeks to provide a method for managing microporous, mesoporous and macroporous adsorbent particles within a manufacturing environment, whereby the risk of ingress of particles within the respirable range is significantly reduced or eliminated, and the risk of contamination of the end manufactured product and the production machinery itself is significantly reduced or eliminated, whilst at the same time the full functionality and efficacy of the properties of the powder in its natural or synthesised small particle state are maintained.

Therefore, according to the present invention there is provided a method for processing microporous and/or mesoporous and/or macroporous adsorbent particles comprising the steps of:

(i) agglomerating said microporous and/or mesoporous and/or macroporous adsorbent particles, by a spray-drying process, thereby to produce a generally spherical, free-flowing, spray-dried, agglomerated adsorbent powder;

(ii) activating said powder emerging from step (i) by a heating process;

(iii) bringing said powder emerging from step (ii) into intimate contact with a substrate; and

(iv) subjecting said powder-and-substrate matrix emerging from step (iii) to an alternating electrical field (AEF), thereby to reduce said powder to its pre-agglomerated particle size and state, whilst remaining in intimate contact with said substrate.

In order for microporous, mesoporous and macroporous adsorbent particles to function at their maximum efficiency in adsorbing specific target molecules in their end product use, the maximum available surface area of the adsorbent particles is required to be exposed to the target molecules to be adsorbed.

To achieve the maximum surface area available for adsorption, the adsorbent powder is required to be in its natural or synthesized state and particle size, which will normally be in the range of between 0.1 μm and 40 μm.

The creation of a powder that will flow easily within a manufacturing process whilst virtually eliminating airborne particles within the respirable range from particles within the range of 0.5 μm and 10 μm can be achieved by spray-drying the particles into a larger spherical particle powder form.

Using spray-drying technology, adsorbent particles may be readily agglomerated in a controlled manner into powders of generally spherical mean particle size in the range of 20 μm-1000 μm or even greater, without the use of chemical binders.

Chemical binders are undesirable since they inhibit the efficiency of the adsorbent particles by physically blocking the pathway into a substantial fraction of the crystalline structure of the adsorbent particles where target molecules are to be adsorbed.

Preferably a recirculatory type of spray-drying system is used to ensure a narrow particle size distribution of the agglomerated particles.

Preferably the adsorbent particles are spray-dried to create a binder free and free-flowing powder of generally spherical mean particle size in the range of 20 μm-500 μm, or more preferably 40 μm-500 μm

In preferred embodiments, the generally spherical mean particle size of the spray-dried powder is in the range of between 40 μm-400 μm, more preferably 50 μm-300 μm, more preferably still 60 μm-200 μm, and most preferably 100 μm-150 μm.

Following the spray-drying process and depending upon the specific type of adsorbent powder being processed, the adsorbent powder may be required to be activated. Activation is the process of removing contaminating molecular compounds, including water, from the pores of the crystalline structure of the adsorbent powder. Activation significantly increases the efficiency of the adsorbent in adsorbing specific target molecular compounds.

Although the precise process of activation varies from adsorbent type to adsorbent type, generally, activation requires that the adsorbent powder is heated to temperatures exceeding 125° C. for a period exceeding 30 minutes and then, if conditions require and depending upon the specific type of adsorbent being activated, flushing or purging the powder with a dry gas such as nitrogen or dried air.

After the activation process, the result is an activated, free-flowing spray-dried adsorbent powder that does not contain binders or any other contaminant and is in its most efficient state and condition to adsorb specific target molecules.

In preferred embodiments of particle management process according to the present invention, the free-flowing spray-dried activated adsorbent powder may be brought into intimate contact with a fibrous or porous substrate.

A number of methods of achieving intimate contact between the free-flowing adsorbent powder and fibrous or porous substrate may be utilised in the process of the present invention. These methods include, but are not limited to:

1. Combining the generally spherical free-flowing spray-dried adsorbent powder with fibres in the range of 1 mm-25 mm in length within an air-laid chamber and then transporting the fibre and free-flowing spray-dried activated adsorbent powder blend onto a permeable conveyor under which a low air pressure suction force is applied to create a web.

2. Scattering the generally spherical free-flowing spray-dried adsorbent powder onto the surface of a pre-manufactured fibrous or porous, air-permeable substrate using conventional metered powder scattering equipment.

3. Applying either a positive or negative electric charge to the generally spherical, free-flowing, spray-dried, adsorbent powder whilst simultaneously discharging the powder, via a compressed dry gas propellant system, onto the surface of a fibrous or porous, air-permeable substrate which is transported upon or is otherwise in intimate contact with an earthed or opposing charge support. The electrically charged generally spherical, free-flowing, spray-dried, adsorbent powder particles are attracted to the fibrous or porous substrate by the consequent opposite and attractive electrostatic forces present. This industrial process is commonly known as “Powder Coating”.

Suitable fibrous, air-permeable substrates for use in embodiments 2 and 3 above include non-woven fabric, paper, woven fabric, and felt. Alternatively, the air permeable substrate may be an open cell foam. The air-permeable substrate is preferably compostable in accordance with EN 13432 or ASTM D6400. Once the generally spherical, free-flowing, spray-dried powder is in intimate contact with the fibrous or porous substrate, the entire matrix is then subjected to an Alternating Electrical Field (AEF) of alternating voltage which has the effect of reducing the particle size of the agglomerated generally spherical free-flowing spray-dried adsorbent powder back to its original pre-spray-dried state and particle size whilst remaining in intimate contact with the fibrous or porous substrate. The AEF Step (iv) is preferably carried out at substantially atmospheric pressure.

Preferably, the voltage applied to generate the AEF is in the range of 1 kV-250 kV. In preferred embodiments, the voltage applied to generate the AEF is in the range of 10 kV-200 kV, preferably 20 kV-150 kV, more preferably 30 kV-100 kV and most preferably 40 kV-70 kV. In an alternative, but equally preferred embodiment, the voltage applied to generate the AEF is in the range of 20 kV-35 kV.

Preferably, the AEF is in the frequency range of between 10 Hz-100 kHz. In preferred embodiments, the AEF is in the frequency range of 50 Hz-80 kHz. In alternative, but equally preferred embodiments, the AEF is in the frequency range of between 10 kHz-70 kHz, preferably 20 kHz-60 kHz, and most preferably, 50 kHz-55 kHz.

The AEF may be configured with sinusoidal or square-wave alternating currents between utility frequencies of 50 Hz-60 Hz or with special pulsed wave forms, depending upon the variable conditions of the generally spherical free-flowing spray-dried powder size, the rate of dispersion of the generally spherical free-flowing spray-dried powder onto the surface of the fibrous or porous substrate, and the fibrous or porous substrate type, density and thickness.

Because the adsorbent powder remains in intimate contact with the fibrous or porous substrate whilst being subjected to an AEF of alternating voltage, airborne dust is minimised or eliminated, since the powder becomes entrained within the fibrous or porous substrate as a result of the forces generated by the AEF. This has the coincident effect of reducing the particle size of the agglomerated generally spherical free-flowing spray-dried adsorbent powder back to its original pre-spray-dried state and particle size, by overcoming the hydrostatic forces created within the spray-drying process to combine the original particles into larger agglomerated particles.

Following the application of the alternating electrical field, the resultant powder-and-substrate matrix may be consolidated by applying heat and/or pressure. In preferred embodiments, the resultant powder-and-substrate matrix is subjected to a heated-through air process, thereby to consolidate said fibres by partial melting, and simultaneously to attach said partially melted fibres to said powder particles incorporated in said powder-and-substrate matrix, thereby to prevent diffusion of said powder particles from said substrate.

The method may further comprise the additional step of:

(v) laminating at least one surface of the powder-and-substrate matrix emerging from step (iv) with a polymer sheet.

The polymer sheet is preferably compostable in accordance with EN 13432 or ASTM D6400 and may also be perforated and/or is gas-permeable.

Using this method of managing the adsorbent powder allows the process to be carried out in a virtually dust free environment with the benefit that the atmosphere surrounding the manufacturing process is much less likely to contain particles of adsorbent within the respirable range. Also, contamination of both the manufacturing equipment and the resulting end manufactured product is also greatly reduced and in some circumstances, may be completely eliminated.

In order that the present invention may be fully understood, preferred embodiments thereof will now be described in detail, though by way of example only, with reference to the accompanying drawings, in which:

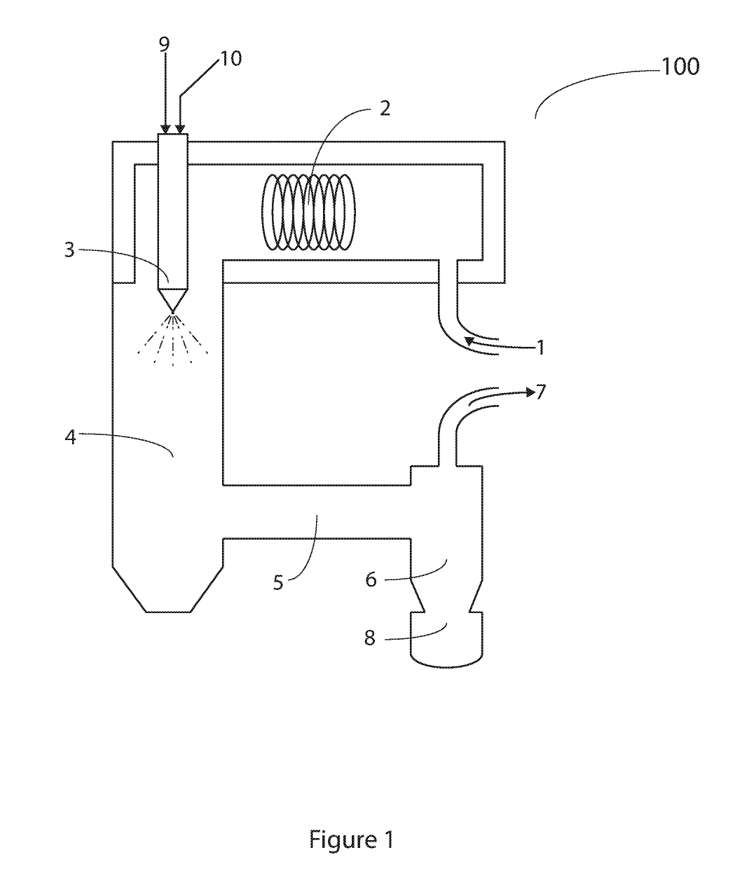

FIG. 1 shows a typical process layout for spray-drying an adsorbent powder to create a generally spherical, free-flowing, agglomerated adsorbent powder of particle size in the range of 20 μm-500 μm;

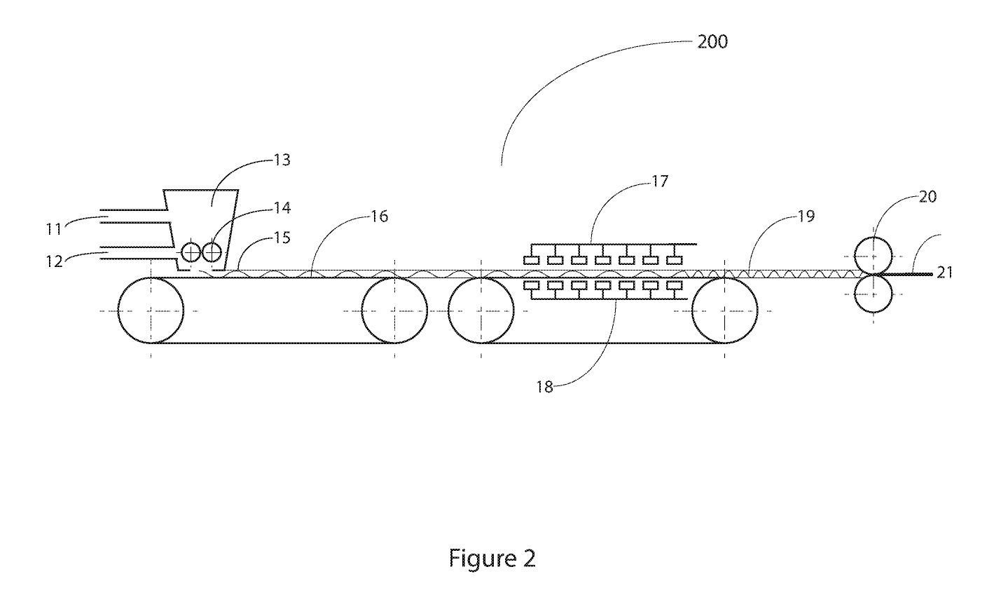

FIG. 2 shows a typical process layout for incorporating a generally spherical, free-flowing, spray-dried, agglomerated adsorbent powder within an air-laid, non-woven construction and subsequently subjecting the resulting formed web to an Alternating Electrical Field (AEF);

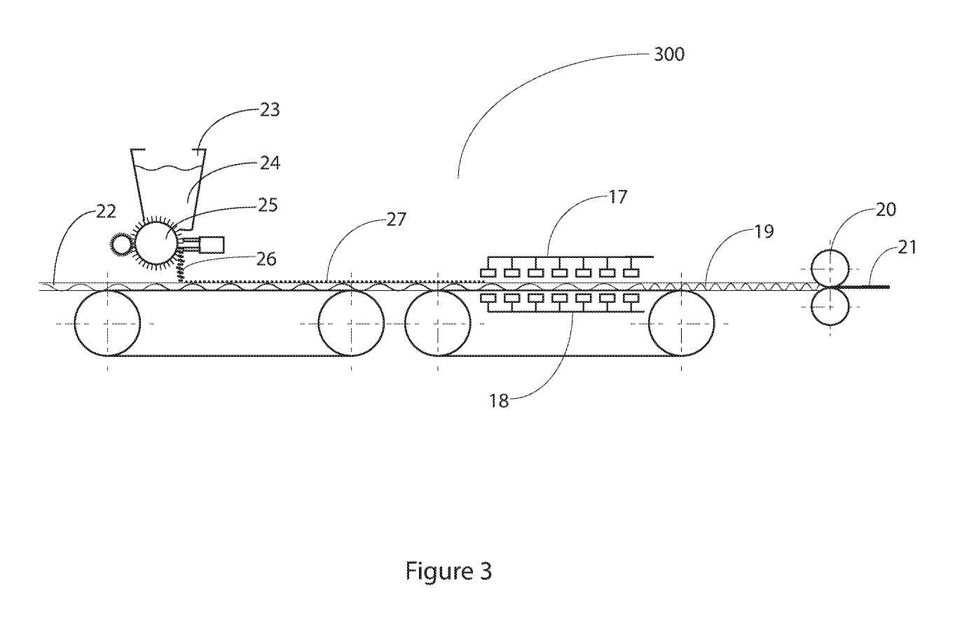

FIG. 3 shows a typical process layout for dispersing a generally spherical, free-flowing, spray-dried, agglomerated adsorbent powder onto the surface of a pre-manufactured fibrous or porous substrate, and subjecting the resulting matrix to an AEF;

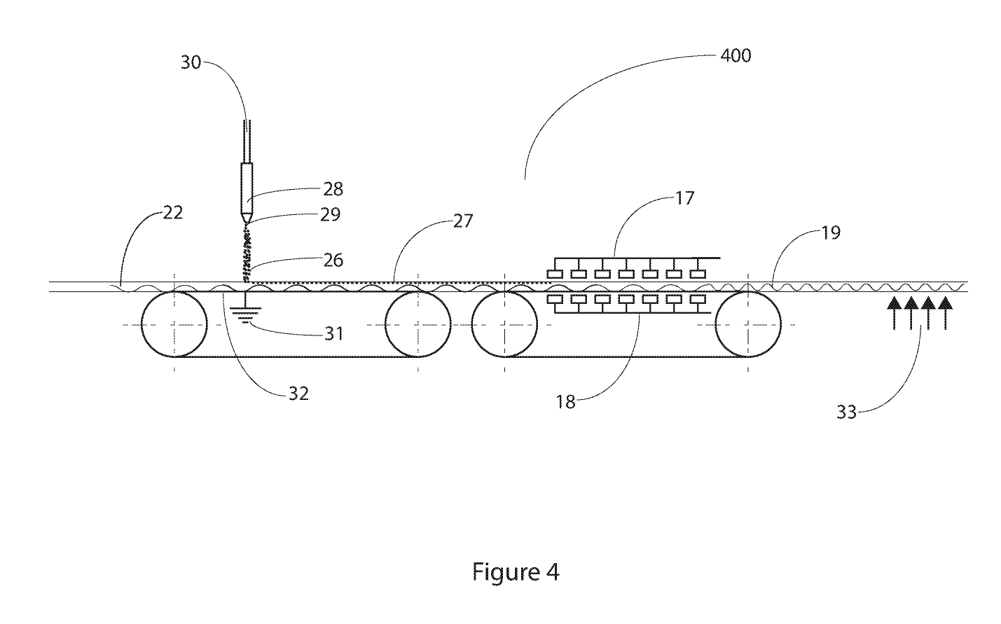

FIG. 4 shows a typical process layout for applying the generally spherical, free-flowing, agglomerated adsorbent powder by the powder coating process to a pre-manufactured fibrous or porous substrate, and then subjecting the resulting matrix to an AEF; and

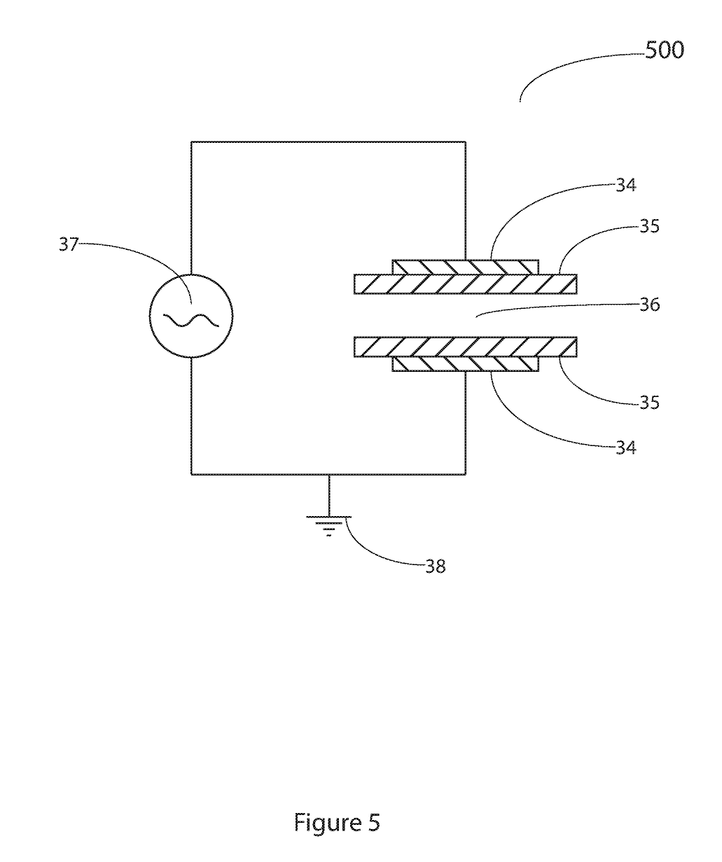

FIG. 5 shows a schematic general arrangement of a typical AEF system.

Referring first to FIG. 1, there is shown a typical process layout, generally indicated 100, for spray-drying an adsorbent powder. An adsorbent powder and water solution, suspension or mixture 10 is fed into a nozzle 3, coincident with an atomising gas 9. The resulting mixture exits the nozzle 3 in a spray configuration into a drying chamber 4, where it is mixed with a drying gas 1, that has been heated by a heating element 2. After exiting the drying chamber 4, the now dried, generally spherical, free-flowing, agglomerated adsorbent powder passes into chamber 5 prior to entering the cyclone chamber 6. Within the cyclone chamber 6, the dried, generally spherical agglomerated powder is collected in the bottom of the chamber 8, whilst the drying gas exits the system via a discharge orifice 7.

Referring now to FIG. 2, there is shown a typical process layout, generally indicated 200, for forming an air-laid web structure 15. The air-laid web structure 15 is formed by blending fibres, introduced into an air-laid chamber 13 via port 12, in combination with the generally spherical, free-flowing, spray-dried, agglomerated adsorbent powder emerging from the spray-drying step described above with reference to FIG. 1, which is injected into the air-laid chamber 13 via port 11. The web is formed by the forming head 14 and transported to a conveyor system 16. The fibre and powder web matrix is then transported through an Alternating Electrical Field (AEF) system 17, 18 where the powder is reduced to its original pre-agglomerated state whilst remaining in intimate contact with the fibre matrix 15. Immediately after the AEF process, the now AEF-treated fibre and adsorbent powder matrix 19 may be consolidated into a thin structure 21 by heated compression rollers 20.

Referring now to FIG. 3, there is shown a typical process layout, generally indicated 300, for dispersing a generally spherical, free-flowing, spray-dried, agglomerated adsorbent powder 26 onto a pre-manufactured non-woven substrate 22. The powder 26 is dispersed onto the surface of the pre-manufactured non-woven substrate 22 via a conventional metered scattering head 25 which in turn is fed by a hopper 23 where the generally spherical, free-flowing, spray-dried, agglomerated adsorbent powder emerging from the spray-drying step described above with reference to FIG. 1 is stored in bulk form 24. After dispersing the powder 26 onto the surface 27 of the pre-manufactured non-woven 22, the fabric and adsorbent powder matrix is then transported through an AEF system 17, 18 where powder is reduced to its original pre-agglomerated state, whilst remaining in intimate contact with the fabric matrix. Immediately after the AEF process, the now AEF-treated fabric and adsorbent powder matrix 19 may be consolidated into a thin structure 21 by heated compression rollers 20.

Referring now to FIG. 4, there is shown an alternative process layout, generally indicated 400, for dispersing the generally spherical, free-flowing, spray-dried, agglomerated adsorbent powder 26 emerging from the spray-drying step described above with reference to FIG. 1, onto a pre-manufactured non-woven substrate 22. The powder 26 is dispersed onto the surface 27 of the substrate 22 via an automated powder coating gun 28 which is fed from a pump via tube 30. Simultaneously, a positive electrostatic charge is applied to the adsorbent powder 26 as it is discharged, at 29, from the automated powder coating gun onto the surface 27 of the non-woven fabric substrate 22. The powder 26 is attracted to the non-woven fabric substrate 22 by the transport system 32 of the non-woven fabric substrate 22 being earthed, at 31. The non-woven fabric and adsorbent powder matrix is then transported through an AEF system 17, 18 where the powder is reduced to its original pre-agglomerated state, whilst remaining in intimate contact with the fabric matrix. Immediately after the AEF process, the fabric and adsorbent powder matrix 19 may be subjected to a heated-through air process 33 to consolidate the fibres of the pre-manufactured non-woven substrate by partial melting, whilst simultaneously attaching said fibres to the powder particles now in their original pre-agglomerated state, again by partial melting of the fibres.

Referring now to FIG. 5, there is shown a schematic representation of a typical general arrangement of an Alternating Electrical Field (AEF) system, generally indicate 500, as utilised in the process steps described above with reference to FIGS. 2 to 4. A discharge gap 36 is situated between high voltage electrodes 34 separated by barrier material 35. A high voltage alternating current generator 37 and grounding point 38 completes the system. The Alternating Electrical Field is applied to the target material within the discharge gap 36 at atmospheric pressure.

### EXAMPLE 1

Cellulosic fibres in a range of lengths between 5 mm-15 mm were fed into the receiving chamber of a pilot line air-laid, non-woven fabric manufacturing machine at a target areal weight of 50 gm⁻² (gsm), coincident with activated, generally spherical, spray-dried, free-flowing agglomerated adsorbent powder, wherein the particle size of at least 95% of the powder was in the range of 100 μm-150 μm in diameter, at an areal target dispersion weight of 50 gm⁻² (gsm). The resulting blend of fibres and powder was transported onto a mesh conveyor and subjected to a low air pressure suction force to create the basic web of a fibre and powder matrix. The web matrix was then subjected to an AEF discharge field of 25 kV and 55 Hz at the rate of at least 0.5 seconds per linear meter. After exposure to the AEF, the web was then subjected to a high pressure, heated nip-roll system to consolidate the fibres into a sheet, whilst coincidentally encapsulating the now processed adsorbent powder within the fibre matrix.

Samples were taken of the now processed adsorbent powder from randomly selected sections of the manufactured roll and were measured for particle size distribution by means of laser diffraction spectrometry. More than 98% of the particles were found to be in the range of 0.5 μm-4 μm, thereby maximising the adsorbent efficiency of the powder.

### EXAMPLE 2

A pre-manufactured, polyester fibre, non-woven fabric of areal weight 50 gm⁻² (gsm) was scattered on one surface with an activated, generally spherical, spray-dried, free-flowing, agglomerated adsorbent powder, wherein the particle size of at least 95% of the powder was in the range of 100 μm-150 μm in diameter, via a conventional controlled scattering device at a rate of 50 gm⁻² (gsm). Immediately following the controlled scattering process, the non-woven fabric and adsorbent powder matrix was subjected to an AEF of 25 kV and 55 Hz for a period of at least 0.5 seconds per linear meter, and then rewound via a tensioning device to create a roll.

The non-woven fabric and adsorbent powder matrix was then laminated on both surfaces in a secondary process, with a polymer alloy sheet of polybutyrate adipate terephthalate (Polybutyrate or PEAT) and polylactic acid (PLA) at 40 μm thickness, using a polylactic acid based adhesive system to create a laminate structure suitable for containing liquids, whilst simultaneously adsorbing odours emanating from those liquids or liquid vapours.

Upon inspection of sections of the roll taken at random from the entire length of the manufactured roll, it was found that the powder had reverted back to its original state and particle size.

Samples were taken of the now processed adsorbent powder from the randomly selected sections of the manufactured roll, and were measured for particle size distribution by means of laser diffraction spectrometry. More than 98% of the particles were found to be in the range of 0.5 μm-4 μm, thereby maximising the adsorbent efficiency of the powder.

### EXAMPLE 3

A pre-manufactured, polyester fibre, non-woven fabric of areal weight 50 gm⁻² (gsm) was placed upon a conductive support which was connected to earth by a suitable copper grounding cable. The conductive support was located within an enclosed structure incorporating a negative pressure dust recovery system. Using a Nordson™ Encore® HD Automatic Powder Gun, activated, generally spherical, spray-dried, free-flowing, agglomerated adsorbent powder, wherein the particle size of at least 95% of the powder was in the range of 100 μm-150 μm in diameter, was positively charged as it exited via said Powder Gun, assisted by dry compressed air, onto the surface of the now earthed non-woven fabric. The powder was attracted to the surface of the non-woven fabric due to the attractive electrostatic charge between the powder and the now grounded non-woven substrate. The target areal weight of dispersion of the adsorbent powder onto the surface of the non-woven fabric was 50 gm⁻² (gsm).

Following the dispersion of the adsorbent powder onto the surface of the non-woven fabric, the entire matrix was subject to an AEF of 25 kV and 55 Hz for a period of at least 0.5 seconds per linear meter of matrix.

The entire matrix was then subjected to a heated-through air process to partially melt the fibres of the non-woven fabric and thereby bond the fibres of the non-woven fabric together, whilst coincidentally bonding the now processed activated adsorbent powder to the fibres by partial melting of the fibres adjacent to said powder particles.

Samples were taken of the now processed adsorbent powder from randomly selected sections of the manufactured roll and were measured for particle size distribution by means of laser diffraction spectrometry. More than 98% of the particles were found to be in the range of 0.5 μm-4 μm thereby maximising the adsorbent efficiency of the powder.

1. A method for processing microporous and/or mesoporous and/or macroporous adsorbent particles comprising:
agglomerating the microporous and/or mesoporous and/or macroporous adsorbent particles, by a spray-drying process, to produce a generally spherical, free-flowing, spray-dried, agglomerated adsorbent powder;
activating the agglomerated powder by a heating process;
bringing the activated agglomerated powder into intimate contact with a substrate to form a powder-substrate matrix; and
subjecting the powder-substrate matrix to an alternating electrical field (AEF), to reduce the powder to its pre-agglomerated particle size and state, whilst remaining in intimate contact with the substrate.

2. A method as claimed in claim 1, wherein the generally spherical, free-flowing, spray-dried, agglomerated adsorbent powder has a mean particle size in the range of from 20 μm-1000 μm.

3. A method as claimed in claim 1, wherein the heating comprises heating the agglomerated powder to a temperature of at least 125° C. for a period of at least 30 minutes.

4. A method as claimed in claim 1, wherein the AEF is generated by a high voltage alternating power supply, optionally with an alternating voltage in a range of from 1 kV to 250 kV.

5. A method as claimed in claim 1, wherein the activating further comprises purging the agglomerated powder with a dried gas, subsequent to the heating.

6. A method as claimed in claim 1, wherein the subjecting is carried out at substantially atmospheric pressure.

7. A method as claimed in claim 1, wherein the microporous and/or mesoporous and/or macroporous adsorbent particles are selected from Zeolites and Metal Organic Frameworks.

8. (canceled)

9. A method as claimed in claim 1 wherein the microporous and/or mesoporous and/or macroporous adsorbent particles are hydrophilic.

10. A method as claimed in claim 1, wherein the microporous and/or mesoporous and/or macroporous adsorbent particles are hydrophobic.

11. A method as claimed in claim 1, wherein the substrate comprises fibres having a length in a range of from 1 mm to 25 mm, and wherein the bringing further comprises:
dispersing the fibres within an air-laid chamber;
introducing the activated agglomerated powder into the air-laid chamber at a controlled rate;
transporting the resultant fibre-powder blend onto a gas-permeable conveyor transport; and
applying a low pressure suction force under the gas-permeable conveyor transport to create a web of fibres in intimate contact with the powder.

12. A method as claimed in claim 1, wherein the substrate comprises an air permeable substrate, and wherein the bringing further comprises dispersing the activated agglomerated powder onto a surface of the air-permeable substrate at a controlled rate.

13. A method according to claim 12, wherein the air permeable substrate is fibrous and/or selected from a non-woven fabric, a paper, a woven fabric, and a felt.

14. (canceled)

15. A method as claimed in claim 12, wherein the air permeable substrate is an open cell foam.

16. A method as claimed in claim 12, wherein the air permeable substrate is compostable.

17. A method as claimed in claim 12, further comprising laminating at least one surface of the powder-substrate matrix with a polymer sheet.

18. A method as claimed in claim 17, wherein the polymer sheet is compostable.

19. A method as claimed in claim 17, wherein the polymer sheet is perforated.

20. A method as claimed in claim 17, wherein the polymer sheet is gas-permeable.

21. A method as claimed in claim 1, wherein the resultant powder-substrate matrix is consolidated by applying heat and/or pressure.

22. A method as claimed in claim 11, wherein the resultant powder-substrate matrix is subjected to a heated-through air process to consolidate the fibres by partial melting, and simultaneously to attach the partially melted fibres to powder particles incorporated in the powder-substrate matrix to prevent diffusion of the powder particles from the substrate.
